(19) United States
(12) Patent Application Publication
(10) Pub. No.: US 2015/0298127 A1
(43) Pub. Date: Oct. 22, 2015

(54) FLUIDIC CHIP AND WASTE LIQUID PROCESSING METHOD FOR SAME

(71) Applicant: NEC CORPORATION, Minato-ku, Tokyo (JP)

(72) Inventors: Minoru Asogawa, Tokyo (JP); Yoshinori Mishina, Tokyo (JP); Yasuo Iimura, Tokyo (JP); Hisashi Hagiwara, Tokyo (JP)

(21) Appl. No.: 14/646,798

(22) PCT Filed: Nov. 19, 2013
(86) PCT No.: PCT/JP2013/006782

§ 371 Date: May 22, 2015

(30) Foreign Application Priority Data
Nov. 27, 2012 (JP) 2012-258536

(51) Int. Cl. B01L 3/00; B32B 37/12; B32B 38/00; B32B 37/18

(52) U.S. Cl. CPC B01L 3/502707; B32B 37/18; B32B 37/12; B32B 38/0004; B32B 2307/51; B01L 2300/123; B01L 2300/069; B01L 2200/12; B01L 2300/0887; B01L 2300/0864

(57) ABSTRACT

Disclosed is a fluidic chip or the like comprising a structure that does not leak a fluid to the exterior. This fluidic chip has at least two elastic members layered in an intermediate layer provided between a top substrate and a bottom substrate. An attached region, in which the elastic members are mutually attached, and a first non-attached region, in which the elastic members are not attached, are provided between the elastic member layers, and a recess in which a fluid can be stored is formed in the top substrate. In addition, the fluidic chip is provided with a through-hole that communicates between the bottom of the recess and one elastic member, of the at least two elastic members, that is attached to the top substrate side. A channel for the fluid is formed by mutual separation of the layers that form the first non-attached region in accordance with the pressurization by the fluid. The fluid that passes through the region is stored in the recess via the through-hole.

### TECHNICAL FIELD

The present invention relates to a fluidic chip that controls a channel of a microfluid.

### BACKGROUND ART

In recent years, for example, FBI (Federal Bureau of Investigation) has stored human DNA information regarding crimes by using “CODIS (Combined Deoxyribo Nucleic Acid Index System)”. The FBI needs to identify a criminal as quickly as possible by collecting DNA of a living body assumed to be criminal's at a crime scene and collating the collected DNA through the CODIS. A DNA analysis device has therefore been developed to enable DNA analysis at the scene. This DNA analysis device has a microstructure such as a microchannel or a port that forms a channel of a predetermined shape in a substrate. According to the DNA analysis device, various types of operations such as chemical reaction, synthesis, purification, extraction, generation, and analysis of a substance in the microstructure can be performed. A structure that has such a microstructure as a microchannel or a port in the substrate is generically referred to as a “microchannel chip”, a “microchannel device”, or a “fluidic chip”.

The fluidic chip can be put to a wide range of application including gene analysis, a clinical diagnosis, drug screening, and environment monitoring. The fluidic chip is more advantageous than a regular-size device of the same type in that (1) the used amount of sample or reagent is considerably small, (2) an analysis period of time is short, (3) sensitivity is high, (4) the chip can be carried to a scene to enable analysis at the scene, and (5) the chip is disposable.

Such a fluidic chip may have various types of microfluidic control mechanisms typified by microvalves arranged in the midway of a microchannel for the purpose of controlling a continuous flow of a fluid (e.g., liquid or gas) or transfer of fine droplets. An example of such a microfluidic control mechanism is described in PTL 1 or the like.

The PTL 1 discloses a fluidic chip structure having a microfluidic control mechanism that does not require any valve seat or pressure chamber. This fluidic chip has a structure including at least a top substrate, a bottom substrate, and an intermediate layer interpolated between the top substrate and the bottom substrate. On one adhesive surface selected from a group consisting of an adhesive surface side of the top substrate and the intermediate layer and an adhesive surface side of the bottom substrate and the intermediate layer, one or more linear non-adhesive thin layers for the microchannel are formed. On the adhesive surface side in which the microchannel non-adhesive thin layer is present and its opposite adhesive surface side, linear channels are formed to vertically intersect each other via one or more non-adhesive thin layers for a shutter channel and the intermediate layer. A region in which the microchannel non-adhesive thin layer and the shutter channel non-adhesive thin layer vertically intersect each other is referred to as a shutter channel non-adhesive region. A pressure supply port is formed at at least one location on the shutter channel non-adhesive thin layer to bulge the shutter channel non-adhesive region.

PTL 2 discloses an inspection microchip which is compact and requires small amounts of a specimen and a reagent and no marker, an inspection device, and an inspection method. The microchip disclosed in the Literature includes a reaction tank and a waste liquid tank on a substrate, and communicates these two units with each other through a channel. When a pump outside the substrate operates, the channel and an air supply unit suck a fluid or air via the waste liquid tank. As a result, since negative pressure is applied in the reaction tank, various fluids or air supplied through a fluid supply port or an air supply path to the inspection microchip can be introduced into the reaction tank in the channel. A valve part of the air supply path connected to the channel is opened, and accordingly unnecessary waste liquid is pushed out to the waste liquid tank by the air.

### CITATION LIST

### Patent Literature

[PTL 1] Japanese Laid-open Patent Publication No. 2007-309868

[PTL 2] Japanese Laid-open Patent Publication No. 2005-140666

### SUMMARY OF INVENTION

### Technical Problem

However, when the fluidic chip disclosed in the PTL 1 is used for gene analysis, a clinical diagnosis, drug screening, and environment monitoring, waste liquid is stored in a waste liquid tank outside the fluidic chip. This waste liquid tank is fixed outside the fluidic chip, and thus waste liquid calculated by analysis carried out several times at the fluidic chip is stored. When the waste liquid stored in the waste liquid tank is processed, the channel connected to the waste liquid tank must be removed, and thus the waste liquid may leak to the outside of the waste liquid tank. This may cause contamination at a location in which sensitive analysis such as gene analysis is carried out, and a hygienically safe environment cannot be created.

According to the technology described in the PTL 2, a waste liquid unit is installed in the microchip, while the channel is formed on the resin substrate. This channel is directly connected to the side of the waste liquid unit, thus causing a problem of reverse flowing of the waste liquid to flow to other than the waste liquid unit.

Therefore, it is a main object of the present invention to provide a fluidic chip or the like having a structure that prevents leakage of a fluid to the outside.

### Solution to Problem

A a fluidic chip according to an exemplary aspect of the invention includes: at least two elastic members layered in an intermediate layer provided between a top substrate and a bottom substrate, provided between the elastic member layers, an adhesive region in which the elastic members are bonded with each other and a first non-adhesive region in which the elastic members are not bonded, formed in the top substrate, a recess in which a fluid to permit store, and a through-hole that communicates one of at least the two elastic members, which is bonded to the top substrate side, and a bottom of the recess with each other, wherein a channel for the fluid is formed by mutual separation of the layers that form the first non-adhesive region in accordance with pressurization by the fluid, to permit store the fluid that passes through the channel in the recess via the through-hole.

A waste liquid processing method for a fluidic chip according to an exemplary aspect of the invention includes: layering at least two elastic members in an intermediate layer provided between a top substrate and a bottom substrate, providing, between the elastic member layers, an adhesive region in which the elastic members are bonded with each other and a first non-adhesive region in which the elastic members are not bonded, forming, in the top substrate, a recess in which a fluid to permit store, and providing a through-hole that communicates one of at least the two elastic members, which is bonded to the top substrate side, and a bottom of the recess with each other, wherein a channel for the fluid is formed by mutual separation of the layers that form the first non-adhesive region in accordance with pressurization by the fluid, to permit store the fluid that passes through the channel in the recess via the through-hole.

### Advantageous Effects of Invention

The present invention can provide a fluidic chip or the like having a structure that prevents leakage of a fluid to the outside.

### BRIEF DESCRIPTION OF DRAWINGS

FIG. 1 is a top view illustrating a fluidic chip according to a first exemplary embodiment of the present invention.

FIG. 2 is a sectional view cut along the line A-A′ of the fluidic chip 100 illustrated in FIG. 1 (opened state of channel by pressurization).

FIG. 3 is a sectional view cut along the line A-A′ of the fluidic chip 100 illustrated in FIG. 1 (unopened state of channel due to no pressurization).

FIG. 4 is a top view illustrating a fluidic chip according to a second exemplary embodiment of the present invention.

FIG. 5 is a sectional view cut along the line B-B′ of the fluidic chip 10 illustrated in FIG. 4 (opened state of channel by pressurization).

FIG. 6 is a sectional view cut along the line B-B′ of the fluidic chip 10 illustrated in FIG. 4 (unopened state of channel due to no pressurization).

FIG. 7 is a sectional view illustrating a fluidic chip according to a third exemplary embodiment of the present invention, cut along positions similar to those illustrated in FIGS. 1 and 4.

### DESCRIPTION OF EMBODIMENTS

Hereinafter, the present invention will be described in detail with reference to the drawings.

### Fist Exemplary Embodiment

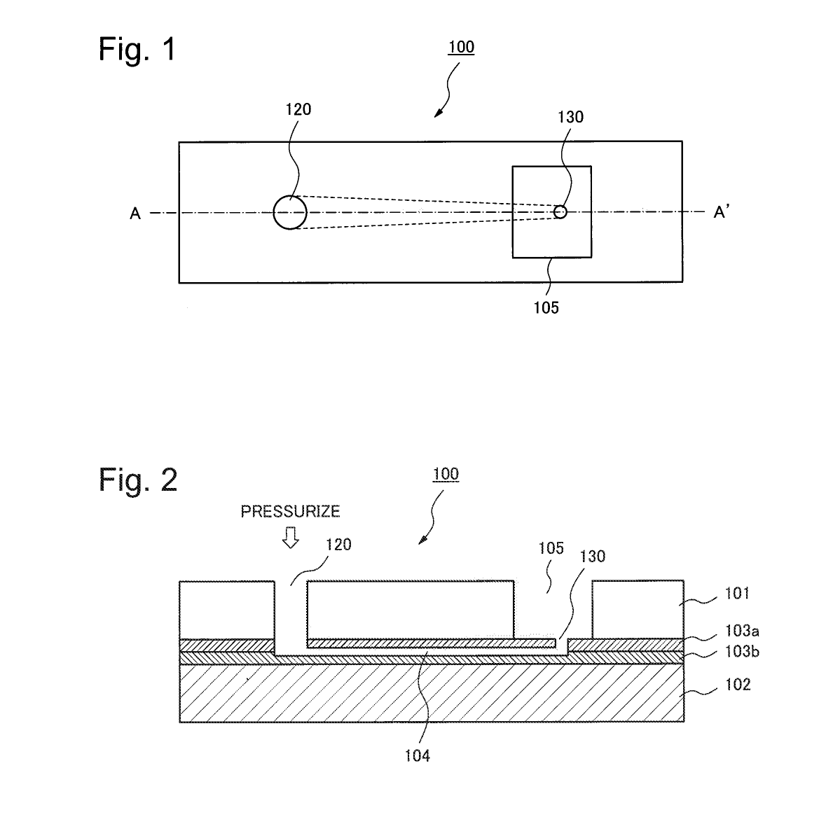

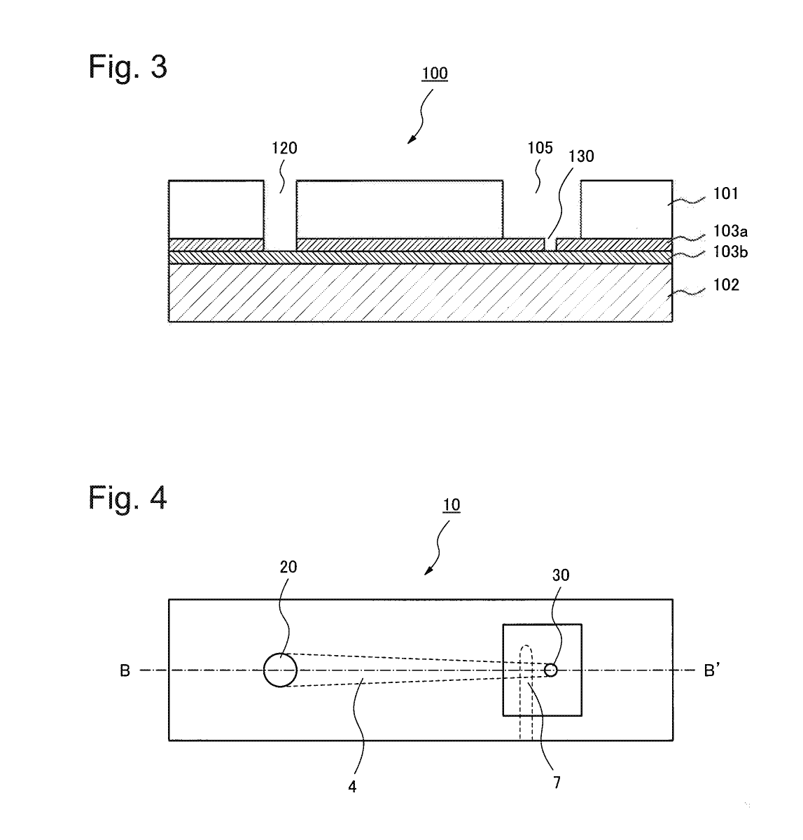

FIG. 1 is a top view illustrating a fluidic chip 100 according to a first exemplary embodiment of the present invention. FIG. 2 is a sectional view cut along the line A-A′ of the fluidic chip 100 illustrated in FIG. 1. FIG. 2 illustrates the fluidic chip 100 in an opened state of a channel set by pressurization (positive pressure) from the outside. FIG. 3 is, as in the case of FIG. 2, a sectional view cut along the line A-A′ of the fluidic chip 100 illustrated in FIG. 1. FIG. 3 illustrates the fluidic chip 100 in an unopened state of the channel (no pressurization from the outside).

The fluidic chip 100 according to the exemplary embodiment includes, as an example, at least two elastic members stacked on intermediate layers 103a and 103b formed between a top substrate 101 and a bottom substrate 102. Between the layers of the elastic members, an adhesive region in which the elastic members are bonded and a first non-adhesive region (hereinafter, also referred to as “microchannel non-adhesive thin layer region” or simply “non-adhesive thin layer region”) 104 in which the elastic members are not bonded are arranged. On the top substrate 101, a recess (hereinafter, also referred to as “waste liquid tank”) 105 capable of storing fluids is formed.

Between one of at least the two elastic members formed along the top substrate 101 side and a bottom part of the waste liquid tank 105, a through-hole (hereinafter, also referred to as “waste liquid port”) 130 is formed to communicate these parts with each other.

In the fluidic chip 100 having such a structure, the layers of the non-adhesive thin layer region 104 are separated from each other by pressurization of the fluid to form a fluidic channel. As a result, the fluidic chip 100 can store the fluid passed through the channel in the waste liquid tank 105 via the waste liquid port 130.

Hereinafter, the fluidic chip according to the exemplary embodiment will be described more in detail. The fluidic chip 100 according to the exemplary embodiment roughly includes the top substrate 101, the bottom substrate 102, and the two intermediate layers 103a and 103b interpolated between the substrates. The more specific structure of the fluidic chip 100 according to the exemplary embodiment is as described below.

The top substrate 101, the intermediate layers 103a and 103b, and the bottom substrate 102 are, as illustrated in FIGS. 2 and 3, bonded and stacked together so as to form a microchannel. In other words, the fluidic chip 100 has a structure in which the intermediate layers 103a and 103b are prevented from being partially bonded by applying an anti-adhesion agent to form the non-adhesive thin layer region 104 for the fluidic channel between the intermediate layers 103a and 103b. As described above, the non-adhesive thin layer region 104 is connected to the waste liquid tank 105 via the waste liquid port 130. It is to be noted that a shape of an opening of the waste liquid tank 105 is not limited to a rectangular shape illustrated in FIG. 2. For example, for the opening shape, various structures can be imagined, such as a groove appropriately formed in a surface of the top substrate 101 or a triangular shape seen from a top surface of the waste liquid tank 105 so as to facilitate user's disposal of waste liquid stored in the fluidic chip.

As illustrated in FIGS. 2 and 3, a bottom surface of the waste liquid tank 105 includes the intermediate layer 103a. The intermediate layer 103a is exposed to the outside at a part forming the bottom surface of the waste liquid tank 105. In other words, in the exemplary embodiment, as illustrated in FIGS. 1 to 3, the part forming the waste liquid tank 105 of the top substrate 101 is bored into a rectangular shape in the top substrate 101. The waste liquid port 130 is provided at the exposed part of the intermediate layer 103a. However, it is to be noted that the structure of the waste liquid tank according to the present invention described by way of the exemplary embodiment is not limited to the structure of the waste liquid tank 105 according to the exemplary embodiment.

In other words, the waste liquid tank according to the present invention may be structured such that instead of boring a top substrate as in the case of the exemplary embodiment, a recess shape is formed in the top substrate and the intermediate layer is exposed outside in at least a partial region of the bottom surface of the recess. In this case, the waste liquid port (through-hole) may be provided at the exposed part of the intermediate layer. A specific example of forming the waste liquid tank into the recess shape will be described below in a second exemplary embodiment (refer to FIGS. 4 to 6).

In the exemplary embodiment, when the top or the bottom substrate 101 or 102 is bonded to the intermediate layer 103a or 103b, or the intermediate layers 103a and 103b are bonded together, for example, permanent adhesion is utilized without using any adhesive. The permanent adhesion is also referred to as permanent bonding. For example, the surfaces of the substrates to which O₂ plasma or excimer UV (ultraviolet) light has been applied can be modified to be permanently bonded together. Silicon rubbers such as PDMS (polydimethylsiloxane), or PDMS and a glass or the like naturally adhere to each other permanently. When the top or the bottom substrate 101 or 102 is PDMS or a glass, PDMS may be used for the intermediate layers 103a and 103b.

Materials of any elasticity, flexibility or hardness can be used for top and bottom substrates 1 and 2. Examples are a cellulose ester substrate, a polyester substrate, a polycarbonate substrate, a polystyrene substrate, a polyolefin substrate, and the like. Specifically, polyethylene terephthalate, polyethylene naphthalate, polyethylene, polypropylene, cellophane, cellulose diacetate, cellulose acetate butyrate, cellulose acetate propionate, cellulose acetate phthalate, cellulose triacetate, cellulose nitrate, polyvinylidene chloride, polyvinyl alcohol, ethylene vinyl alcohol, polycarbonate, a norbornene resin, polymethylpentene, polyether ketone, polyimide, polyether sulfone, polyether ketone imide, polyamide, a fluorine resin, nylon, polymethylmethacrylate, acrylic, polyarylate, a polylactic resin, polybutylene succinate, nitrile rubber, hydrogenated nitrile rubber, fluororubber, ethylene propylene rubber, chloroprene rubber, acrylic rubber, butyl rubber, urethane rubber, chlorosulfonated polyethylene rubber, epichlorohydrin rubber, natural rubber, isoprene rubber, styrene-butadiene rubber, butadiene rubber, polysulfide rubber, norbornene rubber, thermoplastic elastomer, or the like can be used as materials for the top and bottom substrates 1 and 2.

Materials for the intermediate layers 103a and 103b are, for example, in addition to silicon rubber such as PDMS, nitrile rubber, hydrogenated nitrile rubber, fluororubber, ethylene propylene rubber, chloroprene rubber, acrylic rubber, butyl rubber, urethane rubber, chlorosulfonated polyethylene rubber, epichlorohydrin rubber, natural rubber, isoprene rubber, styrene-butadiene rubber, butadiene rubber, polysulfide rubber, norbornene rubber, thermoplastic elastomer, and the like.

The fluidic chip 100 includes a port 120 that serves as an input/output port of gas. As illustrated in FIG. 3, the port 120 is installed by scraping the top substrate 101 to be connected to the non-adhesive thin layer region 104. In the exemplary embodiment, the fluid flowing through the non-adhesive thin layer region 104 is liquid (waste liquid), but not limited to this. As illustrated in FIG. 2, since by applying the positive pressure to the port 120, the non-adhesive thin layer region 104 is bulged to form the channel for the microchannel, the waste liquid can be transferred. For a positive pressure application method, for example, a feed-in tube is connected to each port, and pressurization means (e.g., micropump or syringe) is used.

The top substrate 101, the intermediate layers 103a and 103b, and the bottom substrate 102 are permanently bonded together except the aforementioned adhesive region 104. The non-adhesive thin layer region 104 is configured by applying an anti-adhesion agent on an elastic film. The non-adhesive thin layer region 104 uses flexibility of rubber to return when the channel closes after pressurization. Then, since the non-adhesive thin layer region 104 is adsorbed by self-adsorption, the channel closes.

A width of the non-adhesive thin layer region 104 can be approximately equal to that of a microchannel in a general fluidic chip, or lager/smaller than the general width. For example, the width of the non-adhesive thin layer region 104 is about 10 μm (micrometer) to 3000 μm. Less than 10 μm, pressure for bulging the non-adhesive part to form the microchannel is excessively high, thus creating a possibility of destruction of the fluidic chip 100 itself. On the other hand, when the width of the non-adhesive thin layer region 104 exceeds 3000 μm, while the original purpose is to convey and control a very small amount of liquid or gas to carry out analysis such as chemical reaction, synthesis, purification, extraction, or generation of a substance, an extremely oversaturated amount is set in the channel bulged with the width exceeding 3000 μm.

The waste liquid tank 105 is formed by, for example, cutting an upper part of the top substrate 101. In a lower part of the bottom surface of the waste liquid tank 105, the non-adhesive thin layer region 104 is provided, and formed so as to be connected to the bottom surface of the waste liquid tank 105. The non-adhesive thin layer region 104 is connected to the waste liquid tank 105 via the waste liquid port 130 through which the waste liquid passed by the pressurization flows in.

Since the fluidic chip 100 according to the exemplary embodiment is structured such that the waste liquid tank 105 is provided on the fluidic chip 100, the non-adhesive thin layer region 104 is communicated with the waste liquid tank 105 via the waste liquid port 130. With this structure, the waste liquid transferred through the microchannel in the pressurized state is stored in the waste liquid tank 105. When not pressurized, the fluidic chip 100 can provide an effect of preventing leakage of the waste liquid out of the waste liquid tank 105 by a force to return (restoring force) generated by the flexibility of the elastic film forming the non-adhesive thin layer region 104.

### Second Exemplary Embodiment

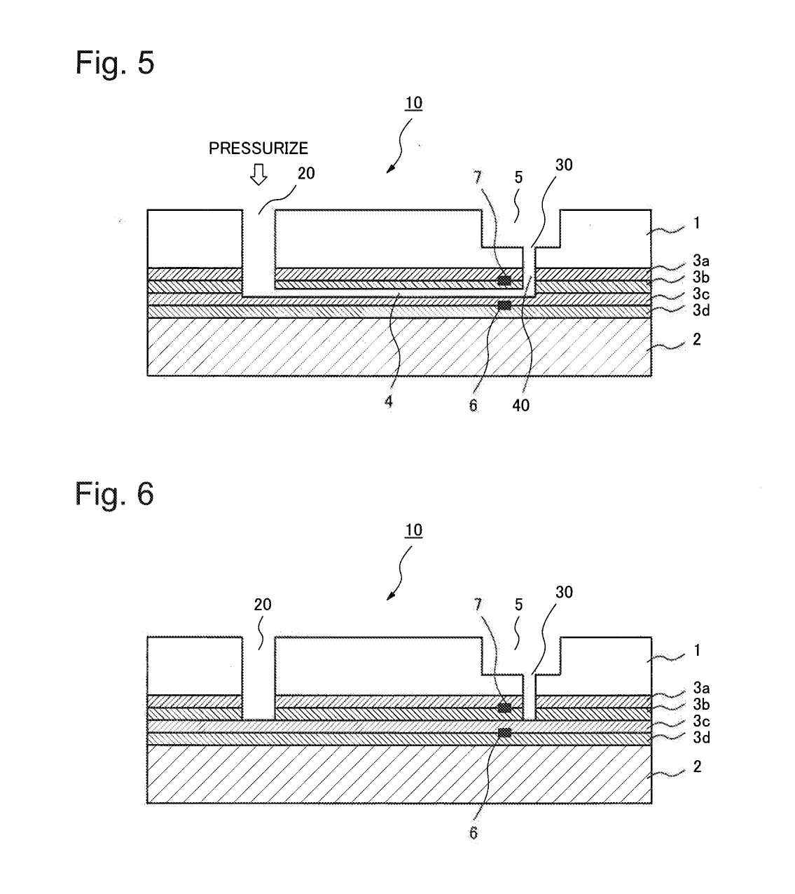

Next, a second exemplary embodiment of the present invention will be described. The second exemplary embodiment is based on the fluidic chip 100 according to the first exemplary embodiment. Referring to FIGS. 4 to 6, a fluidic chip 10 according to the exemplary embodiment will be described in detail. FIG. 4 is a top view illustrating the fluidic chip 10 according to the second exemplary embodiment of the present invention. FIG. 5 is a sectional view cut along the line B-B′ of the fluidic chip 10 illustrated in FIG. 4. FIG. 5 illustrates an opened state of a channel set by pressurization. FIG. 6 is, as in the case of FIG. 5, a sectional view cut along the line B-B′ of the fluidic chip 10 illustrated in FIG. 4. FIG. 6 illustrates a closed state of the channel set due to no pressurization.

The fluidic chip 10 according to the exemplary embodiment includes a top substrate 1, a bottom substrate 2, and four intermediate layers 3a to 3d inserted between the top and bottom substrates 1 and 2. When a waste liquid tank 5 is formed in the top substrate 1, for example, a part of the top substrate 1 is cut into a recess shape. Between the intermediate layers 3b and 3c, a microchannel non-adhesive thin layer region (first non-adhesive region: hereinafter, simply referred to as “non-adhesive thin layer region”) 4 is formed. Between the intermediate layers 3a and 3b and between the intermediate layers 3c and 3d, second non-adhesive regions (hereinafter, referred to as “shutter channel non-adhesive thin layer regions” or simply “non-adhesive thin layer regions”) 6 and 7 are respectively formed.

In the exemplary embodiment, a fluid flowing through a microchannel formed in the non-adhesive thin layer region 4 is liquid (waste liquid). The non-adhesive thin layer region 4 and the non-adhesive thin layer regions 6 and 7 intersect each other so as to partially overlap. The non-adhesive thin layer regions 6 and 7 may be located between the top and bottom substrates 1 and 2, and above and below the non-adhesive thin layer region 4. To prevent reverse flowing of the waste liquid, it is advisable to arrange the non-adhesive thin layer regions 6 and 7 as close as possible to a waste liquid port 30.

The non-adhesive thin layer region 7 is formed between the intermediate layers 3a and 3b. The non-adhesive thin layer region 6 is formed between the intermediate layers 3c and 3d. When positive pressure is applied to at least one of the non-adhesive thin layer regions 6 and 7, the non-adhesive thin layer region 6 or 7 expands. Accordingly, since the expansion of the non-adhesive thin layer region 7 generates a pressure contact force (pressing force), the non-adhesive thin layer region 4 is closed.

The top and bottom substrates 1 and 2 are strong enough to function as valve region fixing members, for example, even when the non-adhesive thin layer region 6 or 7 expands due to a pressure contact force of 200 to 500 kPa (kilo pascal). The valve region fixing member is a part for fixing the expansion of the non-adhesive thin layer region 6 or 7. In the exemplary embodiment, an upper part of the valve region fixing member is the top substrate 1 and a lower part is the bottom substrate 2.

Though not illustrated, a pressure supply port is connected to one end of each of the non-adhesive thin layer regions 6 and 7. The non-adhesive thin layer regions 6 and 7 are arranged to partially overlap the non-adhesive thin layer region 4 vertically. When positive pressure is applied from the pressure supply port, the non-adhesive thin layer region 6 and 7 press regions overlapped with the non-adhesive thin layer region 4 in accordance with the expansion, and thus function as valves. A pressurization method of the non-adhesive thin layer regions 6 and 7 is similar to that of the first exemplary embodiment. By applying the positive pressure to control the expansion of the non-adhesive thin layer regions 6 and 7, a function of the non-adhesive thin layer region 4 as a valve can be achieved.

The waste liquid tank 5 is formed into a recess shape, for example, by scraping a partial region of the top substrate 1. In other words, the waste liquid tank 5 is structured such that a recess is provided in the top substrate 1 and a waste liquid port (through-hole) 30 is provided in a bottom surface of the recess. The non-adhesive thin layer region 6 located below the waste liquid tank 5 provided in the top substrate 1 is stored in the waste liquid tank 5 via the waste liquid port 30. The valve region fixing members according to the exemplary embodiment are the top and bottom substrates 1 and 2.

The fluidic chip 10 according to the exemplary embodiment is configured such that the waste liquid tank 5 is provided in the fluidic chip 10. Further, the non-adhesive thin layer region 4 is communicated with the waste liquid tank 5 via the waste liquid port 30. According to the exemplary embodiment, by, in addition to a force to return (restoring force) generated by flexibility of an elastic film forming the non-adhesive thin layer region 4, the valve functions of the non-adhesive thin layer regions 6 and 7 with respect to the non-adhesive thin layer region 4, an effect of preventing leakage of the waste liquid out of the waste liquid tank 5 can be provided.

In other words, according to the fluidic chip 10 of the exemplary embodiment, in a state where no pressure is applied to a port 20 but the non-adhesive thin layer region 4 provided between the intermediate layers 3b and 3c adsorbs itself, by pressurizing at least one of the non-adhesive thin layer regions 6 and 7 from the outside, the self-adsorbed non-adhesive thin layer region 4 can be closed more surely.

Further, according to the fluidic chip 10 of the exemplary embodiment, during pressurization to the port 20, even in a state where the channel (microchannel) has been formed in the non-adhesive thin layer region 4 provided between the intermediate layers 3b and 3c, by applying pressure large enough to block the channel to at least one of the non-adhesive thin layer regions 6 and 7, the channel can be blocked.

In other words, according to the fluidic chip 10 of the exemplary embodiment, even in the stored state of the liquid (waste liquid) in the waste liquid tank 5, by applying appropriate external pressure to at least one of the non-adhesive thin layer regions 6 and 7, the liquid can be surely prevented from reversely flowing to the port 20 side via the waste liquid port 30.

### Third Exemplary Embodiment

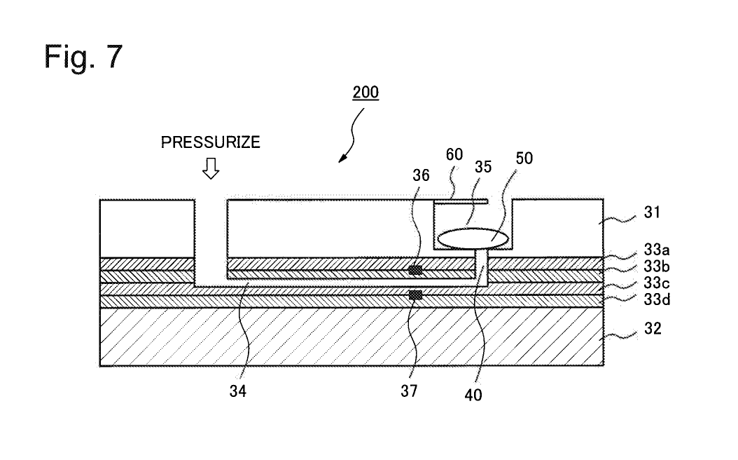

Next, a third exemplary embodiment based on the second exemplary embodiment will be described. FIG. 7 is a sectional view illustrating a fluidic chip 200 according to the third exemplary embodiment of the present invention, cut along positions similar to those illustrated in FIGS. 1 and 4. FIG. 7 is a sectional view of the fluidic chip 200 configured such that an absorbent 50 capable of absorbing a fluid is inserted into the waste liquid tank 5 of the fluidic chip 10 according to the second exemplary embodiment and a lid 60 is further provided. When a waste liquid tank 35 is formed in a top substrate 31, for example, a part of the top substrate 31 is cut into a recess shape. Shapes of the top substrate 31, a bottom substrate 32 and intermediate layers 33a to 33d between the top and bottom substrates 31 and 32 are similar to those of the second embodiment, and thus repeated description is omitted in the exemplary embodiment. The fluid flowing through a microchannel is liquid (waste liquid) as in the case of the first and second exemplary embodiments.

For the absorbent 50 inserted into the waste liquid tank 35, for example, a highly absorbable material such as a polyvinyl formal resin is used. The waste liquid exits from a waste liquid port 40 to be captured into the absorbent 50. The insertion of the absorbent 50 into the waste liquid tank 35 enables prevention of scattering of the waste liquid in the waste liquid tank 35.

The lid 60 provided in the upper part of the waste liquid tank 35 is formed into a shape not to seal the waste liquid tank 35 when the lid 60 is closed. As a material of the lid 60, a hydrophobic material is used. The lid 60 provides an effect of preventing dropping of the absorbent 50 or flowing of the waste liquid out of the fluidic chip 200. When the waste liquid tank 35 is sealed, pressure in the waste liquid tank 35 rises, thus creating a possibility that self-adsorption of a microchannel non-adhesive thin layer region 34 will be released to cause reverse flowing of the waste liquid.

According to the fluidic chip 200 of the exemplary embodiment, the insertion of the absorbent 50 into the waste liquid tank 5 of the second exemplary embodiment causes, in addition to the effects of the second exemplary embodiment, to prevent scattering of the waste liquid in the waste liquid tank 35 when the waste liquid is injected through the waste liquid port 40 into the waste liquid tank 35, and prevent leakage out of the fluidic chip 200. Moreover, the inclusion of the lid 60 in the fluidic chip 200 can prevent dropping of the absorbent 50.

The exemplary embodiments (and Examples) of the present invention have been described. However, the present invention is not limited to the exemplary embodiments. Various changes understandable to those skilled in the art can be made of the configuration and the specifics of the present invention within the scope of the invention.

This application is based upon and claims the benefit of priority from Japanese Patent Application No. 2012-258536, filed on Nov. 27, 2012, the disclosure of which is incorporated herein in its entirety by reference.

### REFERENCE SIGNS LIST

1 Top substrate
2 Bottom substrate
3a to d Intermediate layer
4 Microchannel non-adhesive thin layer region (first non-adhesive region)
5 Waste liquid tank
6, 7 Shutter channel non-adhesive thin layer region (second non-adhesive region)
10 Fluidic chip
20 Port
30 Waste liquid port (through-hole)
31 Top substrate
32 Bottom substrate
33a to d Intermediate layer
34 Microchannel non-adhesive thin layer region (first non-adhesive region)
35 Waste liquid tank (recess)
36, 37 Shutter channel non-adhesive thin layer region (second non-adhesive region)
50 Absorbent
60 Lid
100 Fluidic chip
101 Top substrate
102 Bottom substrate
103a and b Intermediate layer
104 Microchannel non-adhesive thin layer region (first non-adhesive region)
105 Waste liquid tank (recess)
120 Port
130 Waste liquid port (through-hole)
200 Fluidic chip

What is claimed is:

1. A fluidic chip comprising:
at least two elastic members layered in an intermediate layer provided between a top substrate and a bottom substrate;
provided between the elastic member layers, an adhesive region in which the elastic members are bonded with each other and a first non-adhesive region in which the elastic members are not bonded;
formed in the top substrate, a recess in which a fluid to permit store; and
a through-hole that communicates one of at least the two elastic members, which is bonded to the top substrate side, and a bottom of the recess with each other,
wherein a channel for the fluid is formed by mutual separation of the layers that form the first non-adhesive region in accordance with pressurization by the fluid, to permit store the fluid that passes through the channel in the recess via the through-hole.

2. The fluidic chip according to claim 1, wherein in the first non-adhesive region, a second non-adhesive region that comes into contact by pressure with the first non-adhesive region formed in accordance with the pressurization is provided between a position of the pressurization and the through-hole to partially overlap the first non-adhesive region.

3. The fluidic chip according to claim 2, wherein the second non-adhesive region comes into contact by pressure with the first non-adhesive region in accordance with pressurization from a channel different from a pressurization channel to the first non-adhesive region.

4. The fluidic chip according to claim 3, wherein the second non-adhesive regions are individually provided in at least the two elastic members, and come into contact by pressure with the first non-adhesive region in accordance with pressurization to the different channel.

5. The fluidic chip according to claim 4, wherein the second non-adhesive regions are provided to partially overlap at least the first non-adhesive region and to face each other.

6. The fluidic chip according to claim 1, further comprising an absorbent for absorbing the fluid in the recess.

7. The fluidic chip according to claim 6, further comprising a lid in the recess.

8. The fluidic chip according to claim 1, wherein a bottom surface of the recess is configured in a manner that in at least a partial region, the intermediate layer is exposed to the outside and the through-hole is provided at an exposed part of the intermediate layer.

9. A waste liquid processing method for a fluidic chip, comprising:
layering at least two elastic members in an intermediate layer provided between a top substrate and a bottom substrate;
providing, between the elastic member layers, an adhesive region in which the elastic members are bonded with each other and a first non-adhesive region in which the elastic members are not bonded;
forming, in the top substrate, a recess in which a fluid to permit store; and
providing a through-hole that communicates one of at least the two elastic members, which is bonded to the top substrate side, and a bottom of the recess with each other,
wherein a channel for the fluid is formed by mutual separation of the layers that form the first non-adhesive region in accordance with pressurization by the fluid, to permit store the fluid that passes through the channel in the recess via the through-hole.
